(19) United States
(12) Patent Application Publication
(10) Pub. No.: US 2008/0260914 A1
(43) Pub. Date: Oct. 23, 2008

(54) EXTRUDED READY-TO-EAT CEREAL PIECES CONTAINING ENCAPSULATED FLAVOR PARTICLES, CEREAL COMPOSITION AND METHOD

(75) Inventors: Marcus Parsons, Crystal Lake, IL (US); Jeffrey Meyers, Algonquin, IL (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: THE QUAKER OATS COMPANY, Chicago, IL (US)

(21) Appl. No.: 11/736,907

(22) Filed: Apr. 18, 2007

(51) Int. Cl. A23P 1/08

(52) U.S. Cl. 426/96

(57) ABSTRACT

A ready-to-eat cereal is provided. The ready-to-eat cereal product contains encapsulated flavor particles throughout the dough of the product that withstand a cooker/extruder and rupture upon human mastication. The encapsulated flavor particles provide a delayed and intense flavor to the consumer.

### FIELD OF THE INVENTION

The present invention relates to ready-to-eat cereal and snack products. More particularly, the present invention relates to ready-to-eat cereals and snacks that contain encapsulated flavor particles having one or more flavors and to processes for producing such cereals and snacks.

### BACKGROUND

Ready-to-eat (“RTE”) food products include cereals and various types of snacks based on grain or flour. RTE foods, including cereals may be in, for example, a variety of forms, including flake, biscuit and puffed pieces. One convenient method of making such RTE foods, including cereals and snacks, involves use of an extruder operating under relatively high temperature and pressure.

In the field of ready-to-eat (“RTE”) cereals and snacks, flavor characteristics and taste sensations are important factors consumers use to evaluate a product. Thus, the cereal and snack industries have been making a great effort to enhance the flavor characteristics of various RTE cereals and snacks. There are many RTE cereals and snacks that contain a flavor applied to the exterior of the product. However, these flavors can lessen in intensity as the product is exposed to an aqueous medium.

Current flavors are not typically dispersed throughout the dough of an RTE cereal or snack because they would not withstand the high temperatures and pressures of a cooker, extruder, or both.

In view of the foregoing, there exists a need for an RTE product in which the flavor is dispersed throughout the dough of the product and withstands cooking and/or extruding processes, yet is released upon normal human mastication, thereby providing the consumer with a more sustained taste sensation.

There is also a need for a method for making an RTE cereal or snack with the flavor contained throughout the dough that is efficient and cost effective.

### SUMMARY

In accordance with aspects of the invention, an RTE cereal or snack is provided containing encapsulated flavor particles having at least one flavor, the encapsulated flavor particles being distributed throughout the base material of the cereal or snack product. The base material is typically in the form of pieces.

In accordance with further aspects, the RTE cereal or snack pieces have a flavor coating. The flavor coating may contain the same, similar, or different flavors than the encapsulated flavor particles, which have at least one flavor.

In accordance with additional aspects of the invention, an RTE cereal or snack is formed by distributing encapsulated flavor particles having at least one flavor throughout the bulk of the dough of the cereal or snack product prior to cooking and/or extruding the dough into pieces.

In further aspects, the pieces are coated with a flavor coating.

### BRIEF DESCRIPTION OF THE FIGURE

FIG. 1 is a schematic diagram illustrating the process and system in accordance with the present invention.

### DETAILED DESCRIPTION

A ready-to-eat (RTE) cereal or snack is provided having encapsulated flavor particles containing at least one flavor distributed throughout the base material of the cereal or snack product. The base material is in the form of cereal or snack pieces. The base material of the ready-to-eat cereal or snack may be made by any suitable method for making RTE cereals such as methods involving flaking, rolling, extruding, or “shooting” cereal grains from puffing guns.

More particularly, the RTE cereal or snack is a cooked flour or grain-based food product containing encapsulated flavor particles having at least one flavor. The encapsulated flavor particle is a flavor that is encapsulated to be capable of withstanding the elevated temperatures and pressures of a cereal cooker/extruder, resisting rupturing.

The encapsulated flavor particles are generally stable during production and formation of the RTE cereal or snacks. The encapsulated flavor particles rupture upon normal human mastication, thereby releasing the flavor into the mouth of the consumer. The flavor can provide a distinct taste sensation to the consumer.

In at least one aspect, the encapsulated flavor particles comprise natural and/or artificial flavorings.

In another aspect, the encapsulated flavor particles are uniformly dispersed throughout the cereal or snack pieces.

The diameter of the encapsulated flavor particles may be in the range from approximately 20 μm to approximately 2000 μm, for example, 150 μm to approximately 850 μm. The encapsulated flavor particles may have a total mass of from approximately 0.01% to approximately 3% of the total mass of the RTE cereal or snack pieces.

The cereal or snack pieces may include an additional flavor coating applied to the exterior surface of the pieces. For example, the coating may be formed from a syrup. The coating may be the same general flavor as the encapsulated flavor particles or may be a different or complementary flavor. The flavor coating provides the consumer with an initial taste sensation upon consumption. Then, in one aspect, the consumer will experience a more intense taste sensation upon normal human mastication and rupturing of the encapsulated flavor particles contained throughout the pieces. Thus, the combination of the encapsulated flavor particles and the flavor applied to the exterior of the pieces may provide the consumer with either two or more distinct flavors or with an initial flavor followed by a more intense taste of the same flavor from the rupturing of the encapsulated flavor particles.

During production of the RTE cereal or snack, the encapsulated flavor particles are dispersed throughout the dough, such as by adding to a flour or grain mixture. The dough containing the encapsulated flavor particles is cooked and/or extruded. The cooked and/or extruded material is formed into discrete pieces such as by cutting or slicing.

The coating applied to the exterior surface may be applied by any suitable method and suitable apparatus known in the food processing industry, such as an enrober or a twin-screw conveyer. This flavor material is tasted upon initial consumption of the cereal or snack product.

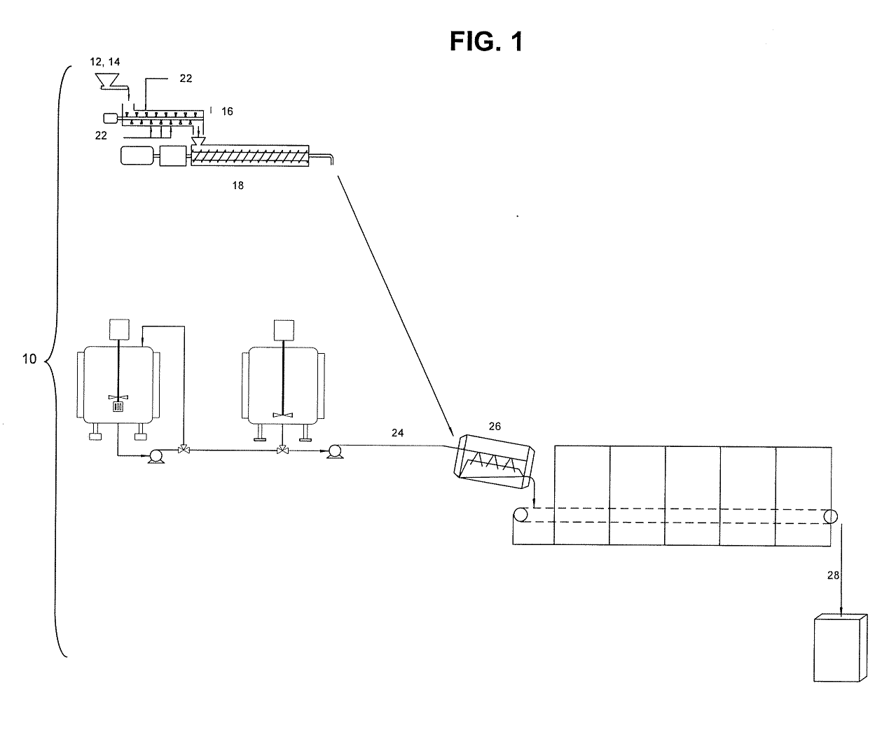

FIG. 1 illustrates a system and method 10 according to an aspect of the invention. A source of a suitable flour mixture 12 is provided. Flour mixture 12 may contain any suitable flour as desired such as corn flour, wheat flour, oat flour and mixtures thereof, as well as other flours, grains and mixtures thereof. Flour mixture 12 may also include sugar in any suitable form such as molasses, unsulphured molasses, honey, or other suitable sugars and mixtures thereof. Flour mixture 12 may also include other natural and/or artificial materials, including salt, additional flavors, vitamins and minerals as desired. In addition, or as an alternative, flavors, including sweeteners, may be applied to the surface of the cooked food pieces as hereinafter described.

A source of encapsulated flavor particles containing at least one flavor is also provided. The encapsulated flavor particles 14 provide at least one distinct flavor and taste sensation in the resulting food product. The encapsulated flavor particles may contain any suitable flavor such as any fruit flavor, any sweetener, cinnamon, chocolate or vanilla flavors. The flavor is encapsulated by the coating. The encapsulated flavor particles 14 remain intact when processed through any cereal cooker/extruder 18 without rupturing.

The encapsulated flavor particles 14 can be a variety of sizes, optimized based on the flavor that is utilized and the RTE cereal or snack product being prepared. The encapsulated flavor particles have a size range from approximately 20 μm to approximately 2000 μm in diameter, for example, approximately 150 μm to approximately 850 μm, or from about 150 μm to about 600 μm. In one embodiment, at least approximately 90% of the encapsulated flavor particles are below 600 μm.

The encapsulated flavor particles 14 are combined with the flour mixture 12, forming a mixture with the encapsulated flavor particles capable of withstanding the cereal cooker/extruder conditions dispersed throughout. The encapsulated flavor particles can be dispersed within the flour mixture in any amount. In one aspect, the encapsulated flavor particles are uniformly distributed within the flour mixture 12.

The encapsulated flavor particles remain intact through the increased temperature and pressure of the cereal cooker/extruder 18. The flavor properties are such that diffusion from the flavor particle is minimized while within the cooker/extruder 18.

System 10 may be designed to be operated on a continuous basis, for example. Generally, in operation, flour mixture 12 and encapsulated flavor particles 14 are fed to a preconditioner 16. Preconditioner 16 may be a paddle mixer, or any other type of mixer, for mixing all of the aforesaid materials together to form a uniform free-flowing wet solid material. Steam and/or water 22 can be added to preconditioner 16, which can be operated to have a residence time of 0.5-5 minutes, for example. Typically, the free-flowing wet solid material composed of the aforesaid ingredients will have a water or moisture content as desired and appropriate for the product being made. For a RTE cereal that is to be extruder processed, the material typically will have a moisture content of approximately 20%±about 3%. The free-flowing wet solid material is then introduced into extruder 18 to heat and cook the free-flowing wet solid material under elevated temperature and pressure. The free-flowing wet solid material is transformed in extruder 18 into a cereal dough, which is cooked in the extruder 18. Extruder 18 heats the food components to a desired temperature for extruder cooking and processing which may be in the range of, for example, 250° F. to 350° F. Upon exiting extruder 18 the cooked food product expands and is cut into pieces of desired length by a suitable cutting mechanism, examples of which are well known in the art. For example, the cutting mechanism may be a reciprocating or rotary cutting device.

Thereafter, if desired, the individual food pieces can have flavors and/or a coating applied to the surface thereof. These materials can be applied by any suitable method and apparatus, including, for example, by an enrober 26 in which the additional material, such as a syrup provided by a source of syrup 24, is sprayed onto the food pieces and subsequently dried in an oven or dryer. The enrober 26 may be composed of a rotating drum in which the syrup is sprayed on the food pieces. After this step, food pieces are dried in an oven or dryer. The cereal pieces are then allowed to cool. Thereafter, the coated food pieces can be suitably packaged at packaging station 28.

In operation of system and method 10, the preconditioned ingredient mixture that exits preconditioner 16 contains encapsulated flavor particles 14 dispersed throughout the cereal dough, and in one aspect, essentially uniformly dispersed throughout the cereal dough.

The encapsulated flavor particles as contained within the cooked cereal pieces may be approximately 0.01% to approximately 5% of the total mass of the cooked cereal pieces, for example, between 0.01% and 3% of the total mass, or between 0.01% and 1.5% of the total mass of the cooked cereal pieces.

In accordance with another embodiment of the present invention, the encapsulated flavor particles 14 could be added directly into the inlet or feed of extruder 18. Alternatively, the encapsulated flavor particles 14 could be added upstream of the extruder feed location. Similarly, encapsulated flavor particles 14 could be added into any suitable flour-based cooking device to form a food product upon cooking, the food product comprising encapsulated flavor particles that rupture upon mastication.

In aspects of the invention, the encapsulated flavor particles are processed to withstand increases in temperature and pressure and processing through a cereal cooker/extruder.

In accordance with another aspect of the invention, a flour or grain mixture containing encapsulated flavor particles dispersed throughout is provided that is suitable for making a cooked, ready-to-eat, food product. The food product may be a ready-to-eat cereal or a snack food, for example. The flour mixture, including the dispersed encapsulated flavor particles, is suitable for processing and cooking in a cereal cooker/extruder. The flour mixture comprises flour or an alternate grain, sweetener, salt, encapsulated flavor particles that remain essentially intact during processing through a cereal cooker/extruder, and optionally natural or artificial flavors, resulting in a flour mixture suitable for processing and cooking in a cereal cooker/extruder. The flour mixture may further comprise a food grade acid. The food grade acid may be selected from malic acid, citric acid, acetic acid and mixtures thereof.

In accordance with another aspect of the invention, a cooked flour or grain mixture is provided that is mixed with encapsulated flavor particles suitable for making a cooked, ready-to-eat food product. The food product comprises flour or an alternate grain, sugar, flavors, and encapsulated flavor particles that withstand the temperature and pressure of the cooker/extruder. The food product may have flavor or a coating of desired material applied on the surface thereof. Such materials can be applied by any suitable method and suitable apparatus, including by spraying, for example.

In accordance with another aspect of the present invention, a cooked flour or grain mixture is provided that is mixed with encapsulated flavor particles suitable for making a cooked, ready-to-eat food product. The food product comprises flour or an alternate grain, sugar, flavors, and encapsulated flavor particles that withstand the temperature and pressure of the extruder/cooker.

Several suitable encapsulated flavor particles are available from Givaudan Flavors Corporation, Cincinnati, Ohio, under the trade designations TasteSaver™ (crazy berry type flavor), PermaSeal® (blue raspberry flavor), UltraSeal™ (lemon flavor) and Flavorburst® (blue raspberry flavor or watermelon type flavor).

The present invention can be more completely understood by reference to the following example.

### EXAMPLE

A ready-to-eat flour-based food product composed of ingredients in accordance with the invention can be made having the following ingredients and amounts in the base mix:

| Ingredient | Amount (% by weight) |
|---|---|
| Flour | 85–95 |
| Sugar (which can be composed of | 3–9 |
| honey and/or molasses) | |
| UltraSeal ™ Flavor encapsulated | 0.01–1.5 |
| flavor particles | |
| Salt and minor ingredients | 1–7 |

A preconditioned flour mixture of the foregoing composition is formed in a preconditioner with the specified ingredients and added steam or water to result in a fixed moisture content of about 17-22%, or between about 17-19%. The preconditioned mixture as a free-flowing wet solid and can be introduced into an extruder at, for example, a temperature of about 100-150° F. and processed through the extruder which operates at a temperature of up to approximately 350° F. Upon exiting the extruder, the cooked resulting product is cut into individual pieces to form a cooked ready-to-eat cereal having encapsulated flavor particles throughout the bulk of the cereal pieces. Typically, the range of the flour and encapsulated flavor particles present in the composition will be in the range of from about 0.1-1.5% encapsulated flavor particles.

The RTE cereal pieces can be coated with a suitable coating as desired, which may be a sweetened syrup. One suitable syrup has the following formula:

| Ingredient | Amount (% by Weight) |
|---|---|
| Sugar | 65–75 |
| Process Water | 15–25 |
| Flavor | 0.1–1.5 |

The syrup ingredients are blended together and applied, such as by spraying, at an elevated temperature to the surface of the cereal pieces from the extruder. Thereafter, the cereal pieces are dried, cooked and packaged.

While the invention has been described with respect to certain preferred embodiments, as will be appreciated by those skilled in the art, it is to be understood that the invention is capable of numerous changes, modifications and rearrangements and such chances, modifications and rearrangements are intended to be covered by the following claims.

What is claimed is:

1. A ready-to-eat cereal comprising:
cereal pieces, each cereal piece having an exterior and comprising cooked cereal dough and a plurality of encapsulated flavor particles containing at least one flavor distributed throughout the cooked cereal dough, the encapsulated flavor particles being rupturable upon normal human mastication.

2. The cereal of claim 1 further comprising a coating comprising a flavor on the exterior of the cereal pieces.

3. The ready-to-eat cereal of claim 2 wherein the coating comprises a different flavor than the encapsulated flavor particles.

4. The ready-to-eat cereal of claim 1 wherein the encapsulated flavor particles have a diameter in the range of from about 20 μm to about 2000 μm.

5. The ready-to-eat cereal of claim 4 wherein at least about 90% of the encapsulated flavor particles have a diameter in the range of from about 150 μm to about 600 μm.

6. The ready-to-eat cereal of claim 1 wherein the encapsulated flavor particles are uniformly distributed throughout the cooked cereal dough.

7. The ready-to-eat cereal of claim 1 wherein the encapsulated flavor particles have a total mass of from about 0.01% to about 1.5% based on the total mass of the cooked cereal pieces.

8. The ready-to-eat cereal of claim 1 wherein the encapsulated flavor particles are capable of withstanding cereal extrusion and cooking conditions.

9. The ready-to-eat cereal of claim 1 wherein the encapsulated flavor particles comprise:
natural flavorings, artificial flavorings or a combination thereof.

10. A method of making a ready-to-eat cereal product comprising:
providing a cereal flour;
mixing encapsulated flavor particles containing at least one flavor into the flour to form a mixture, the encapsulated flavor particles capable of withstanding the conditions of processing by a cereal cooker/extruder without rupturing, but which rupture upon normal human mastication;
cooking the mixture; and
forming the mixture into discrete cereal pieces having an exterior.

11. The method of claim 10 wherein the step of forming the mixture comprises extruding.

12. The method of claim 11 further comprising cutting extruded lengths of the cooked ready-to-eat cereal product into the cereal pieces.

13. The method of claim 10 further comprising coating the exterior of the cereal pieces with a flavor syrup.

14. The method of claim 13 wherein the coating comprises spraying the flavor syrup on the exterior of the cereal pieces.

15. The method of claim 10 further comprising cooking the mixture at a temperature of from about 250° F. to about 350° F.

16. The method of claim 11 further comprising extruding at a pressure of from about 2000 psi to about 3500 psi.

17. The method of claim 10 wherein the step of mixing distributes the encapsulated flavor particles uniformly.

18. The method of claim 13 wherein the encapsulated flavor particles have a total mass, and the total mass is from about 0.01% to about 1.5% of the total mass of the cooked cereal pieces.

19. The method of claim 10 wherein the encapsulated flavor particles comprise:
natural flavorings, artificial flavorings or a combination thereof.

20. The method of claim 10 wherein the coating comprises a different flavor than the encapsulated flavor particles.

21. The method of claim 10 wherein the encapsulated flavor particles have a diameter in the range of from about 20 μm to about 2000 μm.

22. The method of claim 18 wherein at least about 90% of the encapsulated flavor particles have a diameter in the range of from about 150 μm to about 600 μm.
